(19) United States
(12) Patent Application Publication
(10) Pub. No.: US 2010/0084222 A1
(43) Pub. Date: Apr. 8, 2010

(54) SCAFFOLDING SYSTEMS

(76) Inventor: Lewis Roy Cleveland, Ohauiti (NZ)

Correspondence Address: YOUNG & THOMPSON, 209 Madison Street, Suite 500, Alexandria, VA, 22314, US

(21) Appl. No.: 12/519,049

(22) PCT Filed: Dec. 13, 2007
(86) PCT No.: PCT/NZ07/00361

§ 371 Date: Nov. 30, 2009

(30) Foreign Application Priority Data
Dec. 13, 2006 (NZ) 552072

(51) Int. Cl. E04G 5/08; E04G 7/20; B23P 11/00

(52) U.S. Cl. 182/223; 403/292; 29/428

(57) ABSTRACT

The present invention relates to a support component configured to provide a portion of a scaffolding platform, the support component including, a main body, and at least one male connector projecting from the main body, and at least one female connector defined by a cavity formed in the main body, wherein the male and female connectors co-operate with complementary connectors of further support elements to form a scaffolding platform.

### STATEMENT OF CORRESPONDING APPLICATIONS

This application is based on the Provisional specification filed in relation to New Zealand Patent Application Number 552072, the entire contents of which are incorporated herein by reference.

### TECHNICAL FIELD

This invention relates to improvements in or relating to scaffolding systems. In particular the present invention may be employed to provide an improved scaffolding platform which can be readily assembled when needed, and disassembled for transportation.

### BACKGROUND ART

Scaffolding systems can be employed to provide a stable and strong support surface for people working in elevated environments. Well known scaffolding systems generally consist of some form of collapsible framework which supports the ends of one or more scaffolding planks so positioned to allow a person to work in a standing or sitting position.

It is important that the scaffolding employed is both stable and strong enough to support the weight of any persons using it and their tools. These considerations are particularly important in situations where a person who might fall from the scaffolding is in danger of significant physical harm.

The scaffolding planks employed are generally formed from long wooden or aluminium lengths which are one to two inches thick. Due to their bulk and weight these large planks can be difficult and dangerous to raise and lower to and from elevated locations, particularly in bad weather conditions. Furthermore, such large unitary planks can be difficult to transport without an appropriate roof rack, trailer or truck being available.

In many instances it is also a requirement to provide a scaffolding system which runs for a distance greater than the length of one individual scaffolding plank. In such instances scaffolding planks need to have their ends lapped or layered one on top of each other on a horizontal beam of the framework to provide a support of the appropriate length. However, lapped sets of plank ends cause a safety hazard which may be tripped over by workers, putting them at risk of falling from the scaffolding.

Further, it is necessary for adjacent planks to be joined end to end or at least to overlap, substantially overtop of a horizontal support rail. If this does not occur, then the planks have a higher chance of being tipped over when in use.

In most instances, there is a requirement for scaffolding to provide a relatively wide platform for workers which has a width greater than that of a single plank. In most instances two or more planks may be laid side by side to provide such platform. However, this arrangement of sets of planks is not optimum as there is no interlinking or connection provided between the planks, resulting in each flexing and moving independently when loaded. For example, a worker walking along such an array of planks would have their balance unsettled as their weight shifts leg to leg as each independent plank flexes in turn. This problem can again cause a safety issue, particularly when a worker is carrying a load and may not have a clear view of the path they are following.

An improved scaffolding system which addressed any or all of the above issues would be of advantage. In particular, a scaffolding system which allowed a scaffolding platform to be assembled from a number of individual components when required, and which also provided a strong and stable scaffolding platform would be of advantage. Furthermore a scaffolding system which could provide a single unitary platform with a width and length desired by a user would be of advantage.

All references, including any patents or patent applications, cited in this specification are hereby incorporated by reference. No admission is made that any reference constitutes prior art. The discussion of the reference states what their authors assert, and the applicants reserve the right to challenge the accuracy and pertiency of the cited documents. It will be clearly understood that, although a number of prior art publications are referred to herein, this reference does not constitute an admission that any of these documents forms parts of the common general knowledge in the art, in New Zealand or in any other country.

It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

It is an object of the present invention to address the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided a support component configured to provide a portion of a scaffolding platform, said support component including,

a main body, and
at least one connector projecting from said main body,
wherein said at least one connector co-operates with complimentary connectors of further support components to be capable of forming a scaffolding platform.

According to a further embodiment of the present invention there is provided a support clamp configured to locate a plurality of support components arranged to provide at least a portion of a scaffolding platform, said support clamp including,

a plurality of jaws which define a plurality of bearing surfaces
wherein the jaws are configured to move towards one another to locate a plurality of support components.

According to yet another aspect of the present invention there is provided a joining component configured to locate together the ends of two support components, said support components being arranged to provide at least a portion of the scaffolding platform, the joining component including,

a body, wherein two portions of said body define complimentary projections to at least one aperture formed in an end of a support component, and
at least one linkage element configured to connect a support component to the joining component when a portion of the body sits within a complimentary recess formed within the end of a support component.

According to yet another aspect of the present invention there is provided an improved scaffolding system which includes

a plurality of support components substantially as described above, and
a plurality of support clamps substantially as described above, and
a plurality of joining components substantially as described above,
wherein the joining components and support clamps are employed to locate together a plurality of support components to define at least one scaffolding platform.

According to yet another aspect of the present invention there is provided a member configured to be secured to a body, the member including

a male connector
wherein the male connector is configured for use with the invention described herein.

According to yet a further aspect of the present invention there is provided a member configured to be secured to a body, the member including

a female connector defined by a cavity formed in the member,
wherein the female connector is configured for use with the invention described herein.

The present invention provides improvements in or relating to scaffolding systems. In particular, the present invention may facilitate the rapid connection and disconnection of a number of support components which when combined form a scaffolding platform. Preferably the present invention may allow for the construction of a single unitary platform where the length and width of this platform is directly dictated by the current requirements of the user. Those skilled in the art should appreciate that the user may set the dimensions of the platform formed by locating together an appropriate number and arrangement of support components.

Reference throughout this specification will also be made to the present invention incorporating a system of components including a plurality of such support components, in addition to a number of support clamps and joining components used to locate the support components together to form a scaffolding platform. However, those skilled in the art should appreciate that the provision of all such joining components and support clamps substantially as described above need not necessarily be considered essential to the provision of an assembled scaffolding platform in accordance with the present invention.

As discussed above the present invention incorporates or employs the provision of a plurality of support components which when located together can form at least a portion, or the entirety of a scaffolding platform. Preferably each of the support components may have substantially the same form, shape or appearance, allowing large numbers of support components to be manufactured at low cost to implement the present invention.

Preferably a support component includes a main body and at least one male connector which projects from the main body, and at least one female connector which is defined by a cavity in the main body. In a further preferred embodiment each of the male and female connectors defined by or within the main body may have a complimentary shape or fit to one another. The complimentary nature of these male and female connectors can allow substantially identical support components to have their corresponding male and female connectors engaged with one another.

In a preferred embodiment a support component may define a single male connector which projects from and along the entire length of a side wall of the support component. In a further preferred embodiment such a support component may include a single female connector only which is defined by a cavity which runs the length of the opposite side wall of the main body to that which defines the male connector. In such embodiments the support component may therefore have a male connector projecting from one side wall, and a female connector defined in its opposite side wall.

This particular arrangement of male and female connectors of a support component allows a collection of support components to be aligned and located side wall to side wall with the complimentary fit of adjacent connectors. This complimentary arrangement of connectors can assist in locating a set of support components together, preferably to form an entire scaffolding platform.

In an alternatively preferred embodiment, a support component may have at least two male connectors extending from one side of its main body. In this embodiment, the at least two male connectors define a cavity forming a female connector.

In this embodiment, the edges of the cavity defining the female connector are configured to act as both an edge to the female connector, and a male connector. The male connectors are also configured to engage the corresponding female connector of an adjacent support component.

Preferably, a support component's main body may have at least two male connectors extending from each side wall.

In a particularly preferred embodiment, the at least two male on each side of the support component may be vertically displaced from each other.

This embodiment offers the advantages that the support components are essentially symmetrical and so therefore can be used “either way up”. This makes the support components easier to use and install. Further, it also reduces the manufacturing costs associated the member including a female connector as described below.

In a particularly preferred embodiment the internal cross-section of the female connector's cavity increases towards the inside of the cavity.

Preferably, the male connector may be configured to correspond to the cavity forming the female connector.

In a particularly preferred embodiment, the male connector may have a diameter corresponding to the internal cross-section of the female connector's cavity.

Having the internal cross-section of the female connector's cavity increase provides a resistive force and helps to keep adjacent support components in contact. It therefore assists in construction of the scaffolding platform according to the present invention. Further, when the support component is put under load when in use, the shape and configuration of the male and female connectors causes their respective edges to engage. The shape of the respective components is such that there is an added resistance helping to retain the male connector within the female connector. This ensures that the present invention is safer than the loose planks currently used to provide a scaffolding platform.

In a preferred embodiment, the support component may be configured to engage with an adjacent support component via the end wall of each support component.

Preferably, the end on engagement of support components is via a joining component as described herein.

In a preferred embodiment the present invention may also include or provide a support clamp used to locate a plurality of support components together. Such a support clamp may preferably engage with an exterior side wall of a collection of support components located together to urge the side walls of the support components to contact with one another.

Preferably a support clamp provided in accordance with the present invention may be configured to engage a side edge of a support component according to the present invention.

In a particularly preferably embodiment, the jaws may be a male jaw and a female jaw. These jaws may be displaced from one another yet be configured to move together to locate a collection of support components.

In a preferred embodiment the male jaw of a support clamp may define a bearing surface which has a male connector projecting from it. This bearing surface may form the portion of the male jaw which comes into contact with a side wall of a support component, where preferably the male connector of the male jaw has a complimentary fit or shape to a female connector defined in a side wall of a support component. In such embodiments the male jaw may therefore positively engage with the side wall of a support component which defines a female connector.

In a preferred embodiment the female jaw of a support clamp may define a bearing surface which has a female connector recess defined within it. This bearing surface may form the portion of the female jaw which comes into contact with a side wall of a support component, where preferably the female connector of the female jaw has a complimentary fit or shape to a male connector defined in a side wall of a support component. In such embodiments the female jaw may therefore positively engage with the side wall of a support component which defines a male connector.

This set of male and female jaws can be used to clamp together the side walls of the scaffolding platform formed at a particular point along its length. Preferably a scaffolding system provided in accordance with the present invention may include a plurality of such support clamps to locate the side walls of the scaffolding platform formed together at various positions along its length.

In a preferred embodiment the present invention also includes at least one joining component which is configured to locate together the end walls of two support components. Such joining components may be employed to ultimately facilitate the provision a scaffolding platform with a length much greater than the individual lengths of the support components from which it is formed.

Preferably a joining component provided by the present invention may include a body which defines at least two projecting portions with a form or shape complimentary to an aperture formed in the and wall of a support component. A complimentary projecting portion of the joining component may in use be inserted into an aperture formed in the end of a support component to engage the body of the joining component with a support component.

In a further preferred embodiment a joining component's body may define two projecting portions only which project in opposite directions from one another. These opposed projecting portions can therefore be used to locate together the ends of two support components to provide a combination of elements with an increased length.

The advantage of being able to combine adjacent support components in an end on manner is advantageous as it provides an improved scaffolding system with greater safety characteristics. Specially, it is not necessary to join adjacent support components to provide a greater length scaffolding platform in an end on matter directly above a support rail. Therefore, the present invention is easier to install and is not prone to tipping of the support components as occurs in the prior art.

Preferably a joining component may also include or engage with at least one linkage element configured to connect the support component to a joining component's projecting portion when inserted within the and wall of the support component.

In a further preferred embodiment a joining component may include or engage with a plurality of linkage elements being connection pins. Such connection pins may be inserted through slots or apertures provided in a top or bottom surface of a support component near the end of a support component. These linkage pins may then be located in connection apertures formed within a projecting portion of a joining component to resist any force which would normally cause the joining component to be removed from the end of the support component.

The present invention may provide many potential advantages over prior art scaffolding systems.

The present invention allows for the construction of a scaffolding platform from a number of individual support components located together. Preferably through the provision of a number of support clamps which locate the side walls of the conglomerate scaffolding platform together, and a number of joining components which locate the end walls of support components together, an entire scaffolding platform may be formed.

Furthermore, the provision of complimentary male and female connectors in the side walls of support components and also preferably when used in conjunction with support clamps can allow a relatively strong scaffolding platform to be formed.

The present invention may be employed to form a unitary scaffolding platform with dimensions directly dictated by the current requirements of the user. Each unitary platform can eliminate the tripping hazard caused by the overlapped plank ends employed in prior art systems. Furthermore the unitary nature of such a platform also eliminates the independent flexing of planks lying side by side as can be found in prior art systems.

The joining component discussed also allows for the connection of the ends of support components together, without these component ends needing to be sited above a horizontal bar of the scaffolding framework. These joining components may be utilised anywhere required to provide a platform dimensioned to suit the requirements of a user.

The flexible nature of the present invention also allows the single system provided to service a wider number and range of individual applications. Provided enough components are available the present invention may perform in large or small scale roles, eliminating the need for scaffolding users to hold stock of various lengths of planks for different types of jobs. Additional savings in labour and transportation costs are also available through use of the present invention which allows a scaffolding system to be erected, disassembled and transported rapidly by a minimum number of workers.

Further, the present invention offers a scaffolding system which is considerably safer than those known in the prior art. Particularly, this is due to the fact that support components connecting in an end on matter via joining components removes the need for butt-joining or planks to overlap, substantially above a support rail as presently needed. Therefore, the present invention is not prone to tipping of planks and removes a significant risk to the safety of users.

In addition, the present invention is capable of handling significantly larger weights from people or tools than the scaffolding systems known in the prior art.

### BRIEF DESCRIPTION OF DRAWINGS

Further aspects of the present invention will become apparent from the following description which is given by way of example only and with reference to the accompanying drawings in which:

FIG. 1 shows a perspective view of an improved scaffolding system provided in accordance with a preferred embodiment, and

FIG. 2 shows an exploded view of a joining component incorporated into the system discussed with respect to FIG. 1, and

FIGS. 3a, 3b show side and plan cross section views illustrating the action of a support clamp incorporated into the scaffolding system discussed with respect to FIGS. 1 and 2, and

FIG. 4 shows a cross-sectional view of the support components and a preferred embodiment of the male and female connectors, and

FIGS. 5a, 5b shows elongate members according to the present invention with male and female connectors, and

FIG. 6 shows the elongate members secured to respective main bodies to form a support component according to the present invention.

FIG. 7 shows two adjacent support components according to an alternate embodiment of the present invention.

### BEST MODES FOR CARRYING OUT THE INVENTION

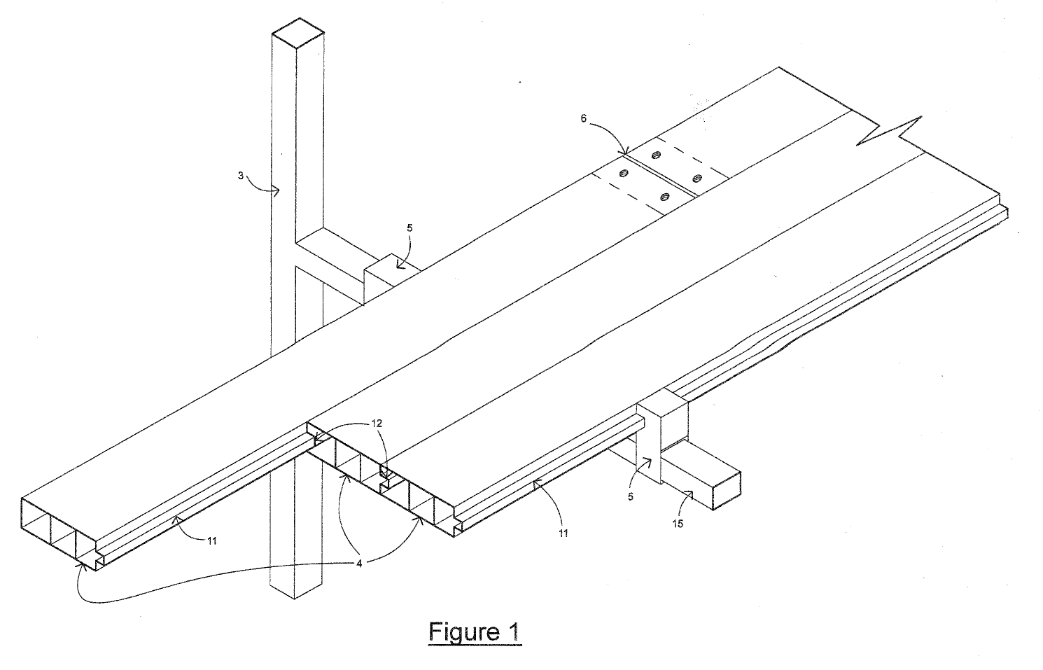

FIG. 1 shows an improved scaffolding system (1) which is formed by a conglomerate scaffolding platform (2) supported by a framework (3) (not fully shown).

The conglomerate scaffolding platform (2) is formed by a plurality of support components (4) which are located together. The side walls of the support components (4) are located together through the use of at least one support clamp (5). In the embodiment shown with respect to FIG. 1 a set of three support components are aligned together with their side walls in contact with one another to set the final overall width of the platform formed.

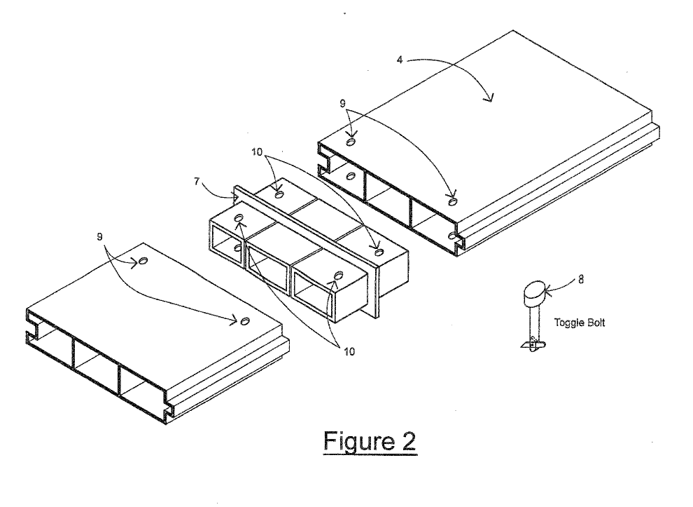

A number of support components can also be joined end to end through the use of joining components (6), as illustrated with respect to FIG. 2.

FIG. 2 shows the provision of a joining component (6) formed from a main body (7) and a number of linkage elements (8). The main body defines two opposed projecting portions which have the complimentary form or shape to apertures formed in the end of each support component (4). These projections can be slotted into the ends of two adjacent support components, and then a number of linkage elements formed by connection pins (8) can be inserted through apertures (9, 10) in the ends of the support components and the projecting portions of the main body (7). Once these pins are inserted the two ends of the support components will be locked together.

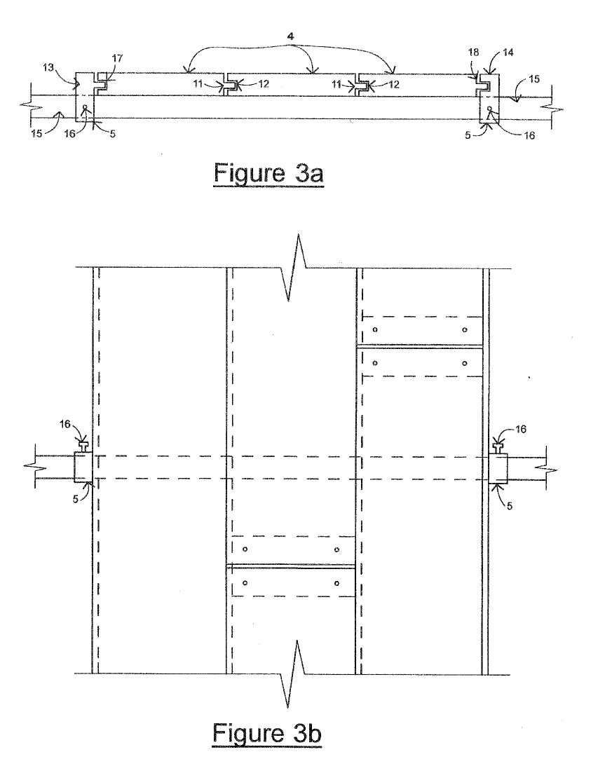

FIGS. 3a and 3b show side and plan cross-section views illustrating the support clamp (5) and the male and female connector systems implemented within each of the support components (4).

As can be seen from the figures provided, each support component (4) includes or defines a male connector (11) formed from a projection which runs down the entire length of one side wall of the support component. Each support component also defines in its opposite side wall a female connector (12) by a recess which runs the length of the side wall. As can be seen from FIGS. 1 and 3a, these male and female connectors have a complimentary fit, allowing them to be used to locate together the adjacent side walls of two support components.

FIGS. 3a and 3b also illustrate the operation of a support clamp (5) which includes a male jaw (13), and a female jaw (14). These jaws can be slid along a mounting shaft (15) towards one another to urge together the side walls of the support components (4). Each jaw also includes a locking screw (16) which can be engaged with the shaft (15) to fix each jaw in place.

As can be seen from FIG. 3a, the bearing surface of the male jaw in contact with a support component defines a projecting male connector (17). A similar arrangement is also present with respect to the female jaw (14) which has a bearing surface which includes a cavity defining a female connector (18). Each of the male and female connectors of the jaws has a complimentary fit to that of the male and female connectors of the support components, allowing the opposed support clamp jaws to positively lock and locate together the exterior end walls of the conglomerate scaffolding platform formed.

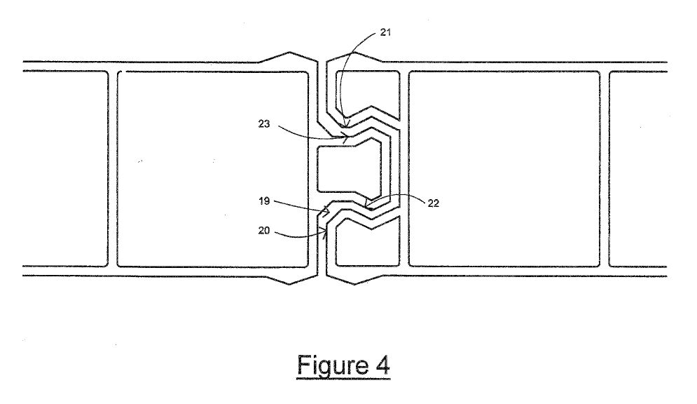

As can be seen in FIG. 4, the complimentary shape and fit of the male and female connectors is such that the two parts easily lock together to secure adjacent support components. The cavity (19) forming the female connector has a cross-sectional area which increases towards the inside of the cavity. This can be seen in FIG. 4 where the change in cross-sectional area is marked as aspects (20) and (21) respectively.

FIG. 4 also shows the shape of the male connector corresponding to the female connector. This is indicated as aspects (22) and (23).

The change in cross sectional areas of the cavity and corresponding male connector is such that when under load, the connector touches the cavity and helps to keep adjacent support components in contact with each other.

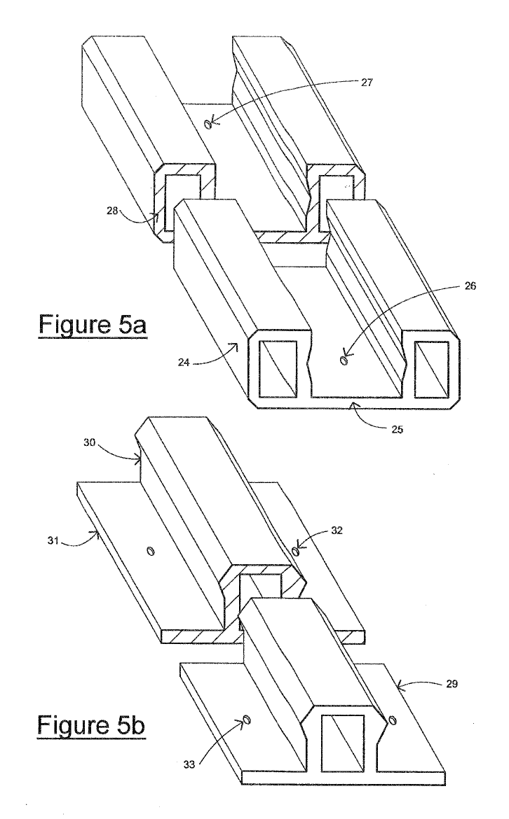

FIGS. 5a and 5b show members (24 & 29) according to the present invention.

Member (24) has a cavity (25) which is configured for use as a female connector. The member is capable of being secured to a unitary blank (not shown) via connection apertures (26) and (27).

The member can be of indefinite length through plane (28).

FIG. 5b shows an alternate member (29) according to the present invention. The member has a male connector (30) extending from its body (31). The male connector (30) is configured to engage with a corresponding female connector of a support component as described herein. The member is able to be secured to a main body to form a support component according to the present invention via apertures representatively shown as (32) and (33).

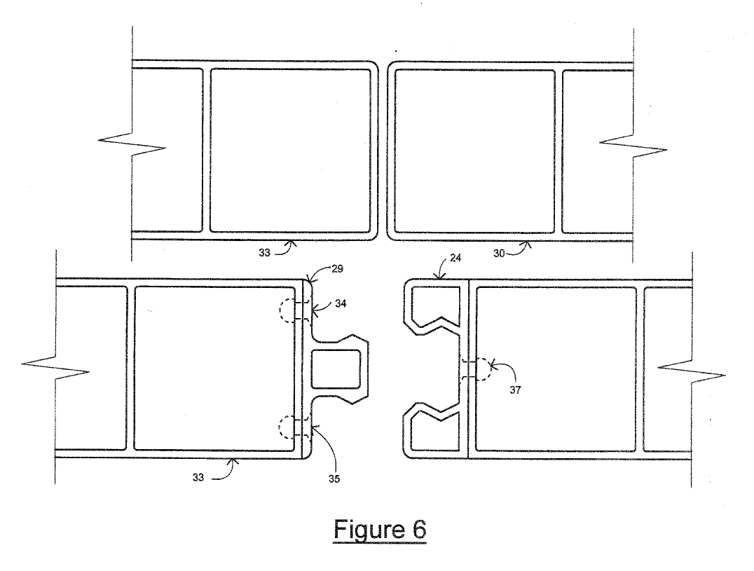

FIG. 6 shows alternate embodiments of a support component with members (24) and (29) secured thereto. The main body (33) has the member (29) secured thereto via rivets (34) and (35) respectively.

The main body (36) has member (24) secured thereto via a rivet (37). It can therefore be seen that members according to the present invention are easily secured to a unitary blank as a support component's main body, allowing the present invention to be retro-fitted to presently available scaffolding planks or to other generic extrusions.

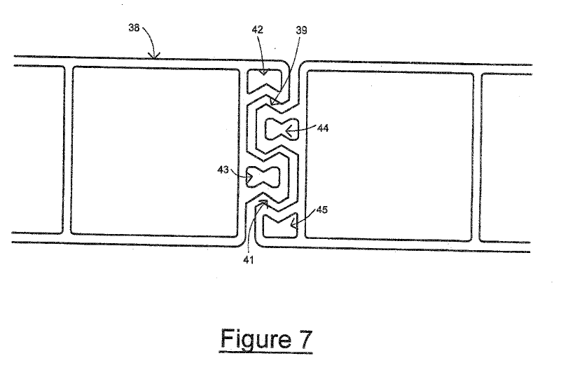

FIG. 7 shows an alternate embodiment of the present invention. The support component has a main body (38) with a female connector formed from a cavity (39) created by two male connectors (42 & 45).

An adjacent support component has a main body (40) having a female connector formed by a cavity (41) created by two male connectors (44 & 45).

The cavities (39) and (41) are configured such that they correspond and engage.

Again, as with the other embodiment discussed above, the internal cross section of each cavity is such that it increases towards the inside of the cavity.

In this embodiment the edges of the cavity are also configured such that they correspond to the shape of the cavity for the female connector. This is substantially as described above and provides a resistance to keep adjacent support components in contact with each other when under load.

However, in this embodiment, the connectors are on distally opposite walls of the main body and vertically displaced from each other. Therefore, the positioning and engagement of the support component's connectors is such that the support components are essentially symmetrical. Therefore, these support components can be used in either orientation and still engage with the connector of an adjacent support component. This decreases the skill level required to construct a scaffolding platform according to the present invention.

As can be seen from the figures supplied, a single unitary scaffolding platform may be implemented through the use of the present invention. Each of the support components used are locked to their adjacent neighbours, eliminating plank overlapping and flexing issues present with the prior art.

Aspects of the present invention have been described by way of example only and it should be appreciated that modifications and additions may be made thereto without departing from the scope thereof as defined in the appended claims.

1-37. (canceled)

38. A scaffolding plank for use with a scaffolding system, said scaffolding system having horizontal members to support a plurality of scaffolding planks and therefore form a scaffolding platform, said scaffolding plank including: a main body; and
connectors on opposite side walls of the main body which cooperate with complementary connectors of adjacent scaffolding planks, wherein the cooperation of complementary connectors on side walls allows scaffolding planks to move length wise relative to each other, and characterised in that the scaffolding plank can be joined end to end with another scaffolding plank away from the horizontal members of the scaffolding assembly.

39. The scaffolding plank as claimed in claim 38, wherein at least one of the connectors on a side of the main body is a cavity having a cross sectional area which changes across the cavity

40. The scaffolding plank as claimed in claim 39, wherein the at least two connectors are a pair of male and female connectors.

41. The scaffolding plank as claimed in claim 40, wherein the cavity runs the length of the main body.

42. The scaffolding plank as claimed in claim 40, wherein the male connector and female connector are on opposite sides of the main body.

43. The scaffolding plank as claimed in claim 38, wherein the end to end joining occurs via a cavity in the end of the main body.

44. A joining component configured to join two scaffolding planks according to claim 38, including a body having two portions that define projections complementary to at least one aperture in the end of a scaffolding plank, and at least one linkage element configured to connect one of the scaffolding planks to the joining component when a portion of the body sits within the complimentary aperture in the end of the scaffolding plank, the two projections extending in opposite directions from one another, characterised in that, the joining components can join two scaffolding planks end to end away from the horizontal members of a scaffolding assembly.

45. The joining component as claimed in claim 44, wherein the joining component includes or engages with at least one linkage element configured to connect the scaffolding plank to the joining component's projecting portion when inserted within the end of the support component.

46. The joining component as claimed in claim 45, wherein the linkage elements are formed by connection pins.

47. An improved scaffolding system which includes:
a scaffolding frame having a plurality of horizontal members, a plurality of scaffolding planks as claimed herein, and a plurality of joining components substantially as claimed herein, the scaffolding system characterised in that the scaffolding planks are connected end to end away from the horizontal members of the scaffolding frame.

48. A member configured to be secured to a body, the member including a male connector, wherein the male connector is configured for use to form a scaffolding plank as claimed in claim 38.

49. A member configured to be secured to a body, the member including a female connector, wherein the female connector is configured for use in forming a scaffolding plank as claimed in claim 38.

50. The member as claimed in claim 48, wherein the male and female connectors are configured to have a complementary shape and fit.

51. A method of constructing a scaffolding system, including the following steps:
(a) assembling at least a portion of a scaffolding frame having horizontal members to support a plurality of scaffolding planks;
(b) connecting a plurality of scaffolding planks to each other using complementary connectors extending from opposite sides of a main body of each scaffolding plank;
(c) joining at least one of the scaffolding planks end to end to another scaffolding plank;
(d) moving the plurality of scaffolding planks relative to each other length wise after step (b);
characterised in that the scaffolding planks are joined to each other at step
(c) away from the horizontal members of the scaffolding frame.

52. The method as claimed in claim 51, wherein the step of moving the scaffolding planks lengthwise relative to each other staggers the end to end joining of laterally adjacent scaffolding planks.

53. The method as claimed in claim 52, including the step of clamping the scaffolding planks to prevent them moving laterally with respect to each other.

54. The scaffolding plank as claimed in claim 41, wherein the male connector and female connector are on opposite sides of the main body.

55. The scaffolding plank as claimed in claim 39, wherein the end to end joining occurs via a cavity in the end of the main body.

56. The scaffolding plank as claimed in claim 40, wherein the end to end joining occurs via a cavity in the end of the main body.

57. The scaffolding plank as claimed in claim 41, wherein the end to end joining occurs via a cavity in the end of the main body.
